(19) United States
(12) Patent Application Publication
(10) Pub. No.: US 2026/0369926 A1
(43) Pub. Date: Nov. 19, 2026

(54) High-Density, Multi-Orientation, Low-Profile Electronic Connector

(71) Applicant: Bota Systems AG, Zurich (CH)

(72) Inventors: Ilias PATSIAOURAS, Zurich (CH); Joan CONILL, Zurich (CH); Pascal COURVOISIER, Zurich (CH)

(21) Appl. No.: 19/678,282

(22) Filed: May 15, 2026

Related U.S. Application Data
(60) Provisional application No. 63/807,231, filed on May 16, 2025.

(51) Int. Cl. H01R 13/58; H01R 13/08; H01R 13/52; H01R 13/66; H01R 13/717; H01R 24/28; H01R 24/76

(52) U.S. Cl. CPC H01R 13/5841; H01R 13/08; H01R 13/52; H01R 13/665; H01R 13/7175; H01R 24/28; H01R 24/76

(57) ABSTRACT

An electronic connector includes a plug and a receptacle. In one implementation the plug and the receptacle that can be used to connect a sensor to an industrial computer. The plug can include a plurality of electrical pins, and the pins can be biased towards contacts on the receptacle. The receptacle includes a greater number of contacts than the plug, in multiples of the number of electrical pins on the plug and a plurality of available mounting orientations to thereby provide multiple available mounting orientations while accomplishing the same connections at each orientation. The plug is specifically configured to serve as a single point of failure within the connection system, thereby limiting potential mechanical or electrical damage to a single, easily replaceable component. By localizing wear and failure to the plug, the use of this connector in a device significantly reduces maintenance and total manufacturing costs compared to prior art solutions.

### RELATED APPLICATION DATA

This application claims priority to Provisional Application Ser. No. 63/807,231, filed on May 16, 2025, the entire disclosure of which is hereby incorporated herein by reference.

### TECHNICAL FIELD

The disclosed implementations relate to mixed signal connectors for electronic devices, particularly those devices used in automation and robotic systems like sensors and low power actuators.

### BACKGROUND

Electronic devices used in automation and robotic systems such as sensors and actuators typically require electrical power to operate and analog or digital signals to communicate with the main computer through a single cable commonly referred as device cable. Industrial devices often operate in harsh environments where high concentration of particles, humidity and vibration is present. A variety of connector designs are available on the market for this purpose and used for such devices, with the most common being circular connectors.

FIGS. 1 and 2 illustrate a conventional sensor device connected to a robot computer. The Sensor 30 connects to the computer 40 through a device cable 20 that provides DC power (typically 12, 24, 48 Volts) and digital connections like Ethernet or Serial RS422 communication (but not limited to these). Typically, a male or female connector 32 is mating with the device receptacle 34 that is usually integrated to the device's housing 35 and attached to a printed circuit board 36 of the internal electronics of the device 30. Ingress protection is achieved with the use of o-rings 37 and 38 to seal off the harsh environment.

Referring to FIG. 3 The electrical connection is established through male 33 and female 31 pins arranged in circular pattern (both the cable connector and the receptacle of the devices are illustrated). The connector's outer bodies 28 and 27 fit together with a keying feature 39 and 29 that serves to align the pins and limit the mating orientation to a single orientation that provides proper connection assignment.

In automation and robotic systems, devices like sensors and actuators are placed on articulated structures and all together comprise the body of the system. The body is moving freely in space with occasional probability of colliding with the environment, or itself. Because of the nature of the system, device cables and connectors are exposed to an increased risk of damage from collision or tugging on the devices cables. Conventional connectors according to prior art are often bulky making them prone to damage by collision. Additionally, when damage occurs, it is usually distributed between the connector and receptacle. Additionally, commonly used connectors have only one mating orientation giving the system designer limited options for routing the cabling optimally to avoid the above-mentioned risk.

Conventional connectors also tend to be limited to the number of connections, typically up to 8 and generally having low density of connections for their size. Additionally, they increase the device cost as both connector and receptacle are assemblies of machined parts and require manual labor to install as they include threads and nuts.

Some attempts have been made to address certain limitations of electrical connectors. For example, U.S. Pat. No. 8,821,172 discloses a ribbon type electrical connector and socket for a computer allowing the connector to be rotated by 180 degrees while preserving polarity.

U.S. Pat. No. 7,311,526 disclose a magnetic connector system for a computer utilizing a plug and receptacle with embedded magnetic elements that maintains electrical contact through magnetic attraction while allowing the plug to break away upon nonaxial force.

U.S. Pat. No. 10,205,291 disclose a connector design for medical applications featuring retractable contacts and a lock mechanism that accommodates various sensors an alignment mechanism including a key-and-detent system.

U.S. Pat. No. 8,535,075 also teaches a dual orientation connecter having a connector tab with first and second major opposing sides and a first set of external contacts formed at the first major side and a second set of external contacts formed at the second major side. The first set of contacts are symmetrically spaced with the second set of contacts and the connector tab is shaped to have 180-degree symmetry so that it can be inserted and operatively coupled to a corresponding receptacle connector in either of two insertion orientations. In order to increase density of the connections, the connector disclosed in this patent uses an electronic device with circuitry to detect the insertion orientation of a plug connector. While this allows for dual-orientation insertion, it relies on complex internal circuitry for detection of orientation.

These conventional designs enable insertion in only two orientations, are limited in connection density, and are not applicable to round connectors of the type used in robotics and other applications and are not applicable to connectors with angled cable exits.

### SUMMARY

The disclosed implementations address one or more of the problems set forth above. The connectors disclosed herein are a robust, compact, and cost-effective solution for industrial and robotics applications with the following features:
Multiple (e.g., more than two) mounting orientations, low profile, and ingress protection
Reduced risk of damage and limiting the damage to the plug side of the connector for easy replacement
High connection density using a novel contact distribution method
Integrated visual indicators and optional electronic components
Reduced manufacturing and material costs.

By addressing these needs, the invention aims to provide a superior alternative to existing connectors by offering more connections in a smaller, more durable form factor.

The electronic connector in accordance with disclosed implementations includes a plug and a receptacle. In one implementation the plug and the receptacle can be used to connect a sensor to an industrial computer. The plug can include a plurality of electrical pins, and the pins can be biased towards contacts on the receptacle. The receptacle includes a greater number of contacts than the plug, in multiples of the number of electrical pins on the plug and the available mounting orientations. If the pins are biased, the biasing force can be accomplished through various mechanical, electrical, or materials properties arrangements. As shown in FIG. 9, the pins can be biased into contact with contacts. For example, the spring-loaded electrical pins 900 may be implemented as pogo pins, which are well-known in the art. Each pogo pin typically comprises a barrel, a plunger, and a spring disposed within the barrel that biases the plunger outward. The plunger makes physical and electrical contact with a corresponding contact 152 on the receptacle 150, and the internal spring provides a continuous contact force to ensure a reliable electrical connection, even in the presence of vibration or minor misalignment.

A plug in accordance with disclosed implementations consists of a plug body with electrical pins extending away from the mating surface and a cable connecting to the electrical pins. The plug body additionally includes indicators (e.g., light emitting diodes) that indicate the connection and device status. The plug body can be over-molded with a semi-transparent rubber, for example, to provide support and strain relief for the cable jacket and seal the plug.

A receptable in accordance with disclosed implementations consists of a body with the contacts which interface with the pins of the plug as well as features for alignment and sealing of the connection. The contacts can be positioned with the same pattern as the electrical pins of the plug. This pattern is repeated in a plurality of orientations to allow the plug to be mounted with different orientations. The body can be integrated on the housing of the device or as a separate part. The receptacle connects to the internal electronics board of the device and connects the shielding of the cable to the device body.

The above-described connector can be implemented for a plurality of electrical contacts and mounting orientations with the receptacle being part of the device body but not limited to it.

The foregoing summary is not intended to summarize each potential implementation or every aspect of the present disclosure.

### BRIEF DESCRIPTION OF THE DRAWINGS

The foregoing Summary, preferred implementations, and other aspects of subject matter of the present disclosure will be best understood with reference to a detailed description of specific implementations, which follows, when read in conjunction with the accompanying drawings, in which:

FIG. 1 illustrates is a perspective view showing a conventional device connection to a robot sensor.

FIG. 2 illustrates a sectional view of the connector assembly of FIG. 1A take at line 1-1.

FIG. 3 illustrates the plug and socket of a conventional connector assembly.

FIG. 4 is a perspective view of an implementation of a high-density, multi-orientation, low-profile electronic connector in accordance with disclosed implementations.

FIG. 5 illustrates sectional views of implementationa high-density, multi-orientation, low-profile electronic connector in accordance with disclosed implementations.

FIG. 6 illustrates a detailed view of an assembly of implementationa highdensity, multi-orientation, low-profile electronic connector with two sealing variant A and B in accordance with disclosed implementations.

FIG. 7 illustrates an assembled view of implementationa high-density, multi-orientation, low-profile electronic connector. with four orientation options design in accordance with disclosed implementations.

FIG. 8 illustrates the topological method for achieving high contact density and multi-orientation connectivity in the connector in accordance with disclosed implementations.

FIG. 9 shows the comparative size and contact geometry between a spherical electrical pin and a flat contact, the pin footprint is approximately 180% the diameter of a contact pad. Two variants are shown of a spring biased pin and contact of a compressed and not compressed pin.

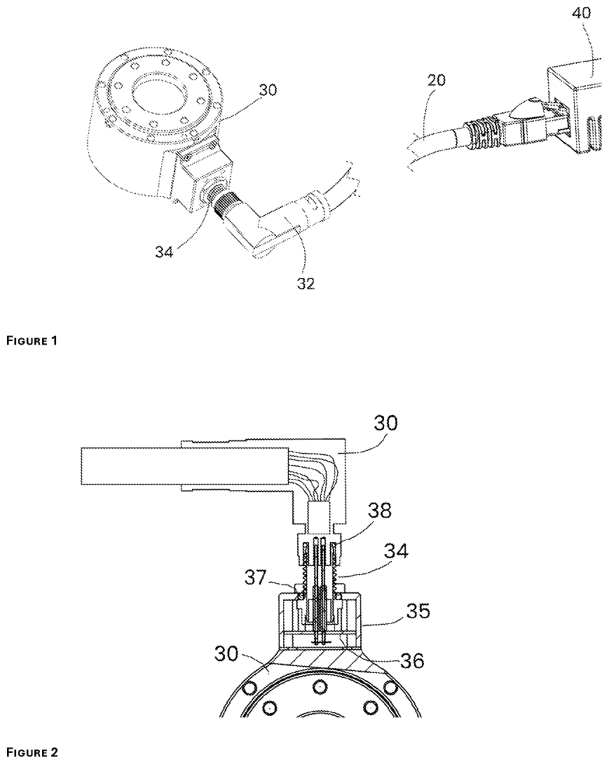

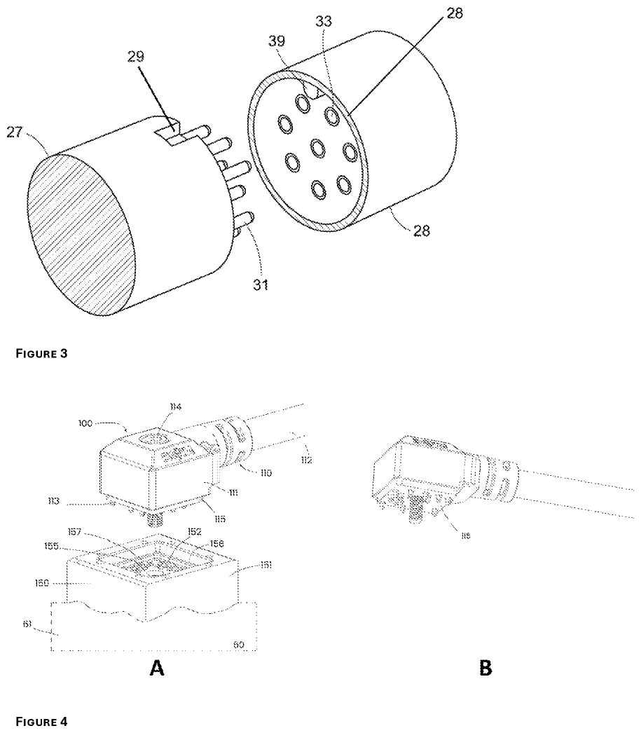

### DETAILED DESCRIPTION

Various implementations and aspects of the disclosure will be described with reference to details discussed below, and the accompanying drawings will illustrate the various implementations. The following description and drawings are illustrative of the disclosure and are not to be construed as limiting the disclosure. Numerous specific details are described to provide a thorough understanding of various implementations of the present disclosure. However, in certain instances, well-known or conventional details are not described in order to provide a concise discussion of implementations of the present disclosure.

Reference in the specification to “one implementation” or “an implementation” or “another implementation” means that a particular feature, structure, or characteristic described in conjunction with the implementation can be included in at least one implementation of the invention. The appearances of the phrase “in one implementation” in various places in the specification do not necessarily all refer to the same implementation.

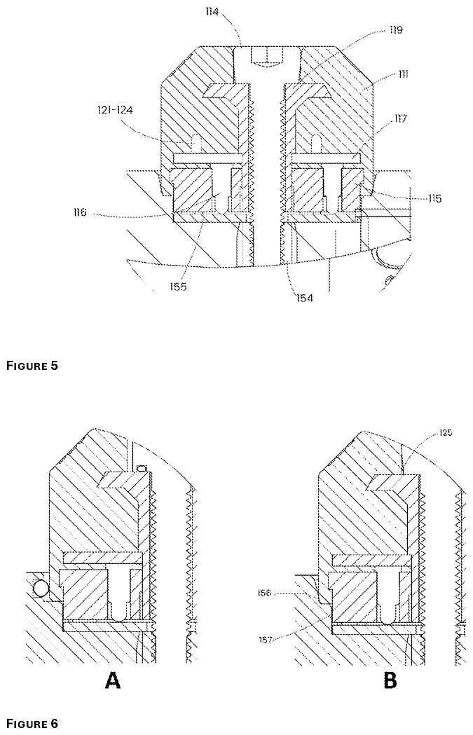

Referring to FIG. 4 an implementation of a connector 100 of the present disclosure is illustrated. The connector 100 includes a plug 110 and a receptacle 150. The plug consists of a body 111, the plug cable 112 that connects to a system device (not shown in FIG. 4, electrical pins 113, and a securing screw 114. The receptacle consists of a body 151 and contacts 152 and connects to, or is incorporated in, a device 60. In one implementation the system device is an industrial PC of a robotic system and the device 60 is a force/torque sensor having a housing 61 with the receptacle body 151 integrated into the design of the device housing 61 and communicating with the system device over, for example, ethernet protocol. The plug 110 is inserted into the receptacle 150 and the two components are held together with the securing screw 114 that presses the electrical pins 113 against the contacts 152 to provide electrical connection.

### PLUG Components

FIG. 5 illustrates the cross section of the assembled connector 100. The plug body 111 contains a printed circuit board 117 that carries four indicators (e.g., LEDs) 121-124, the electrical pins 116 that are held together by the pin carrier 115 and a mechanical support 119 that is used to bear and distribute the mechanical load of the securing screw 114 to the plug body 118. The components of the plug 110 can be fixed together with overmolding techniques resulting in the over-molded plug body 111. The screw 114 can be electrically connected to the metallic mechanical support 119 and can be connected to the shielding of plug cable 112. The plug body 111 can be formed by over-molding a deformable, elastomeric material, such as a thermoplastic elastomer (TPE) or thermoplastic vulcanizate (TPV), around the internal components, including the metallic support insert 119. The metallic insert 119, which may be formed from stainless steel, brass, or aluminum, provides a rigid internal frame. This frame serves as a stable mounting point for the printed circuit board 117 and distributes the compressive force from the securing screw 114. The surrounding elastomeric material absorbs impact energy during a collision through elastic deformation, while the rigid insert 119 prevents damage to the sensitive internal components. Furthermore, the metallic insert 119 electrically connected to the shield of the plug cable 112 and the screw 114, providing a continuous path to ground for effective EMI shielding

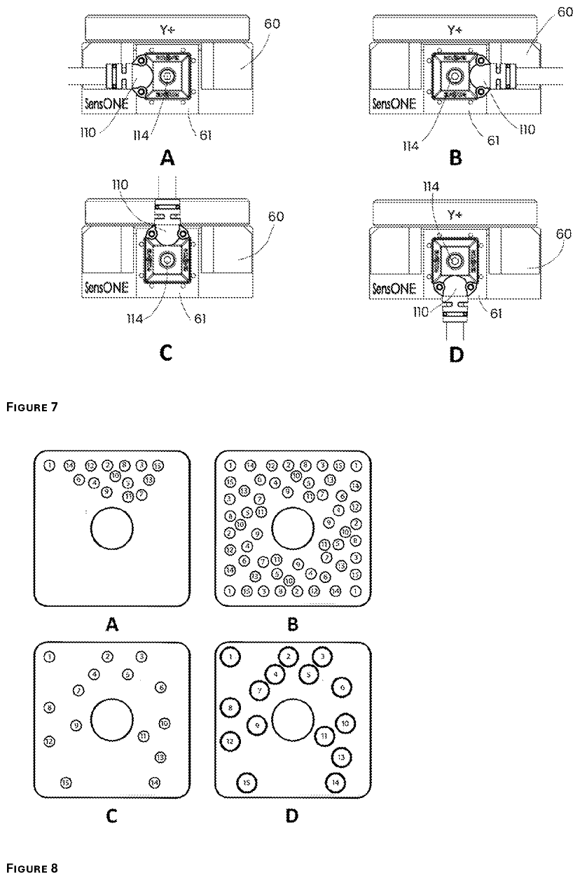

Referring to FIG. 6, B shows one implementation in which the plug body 111 is made from a rubber material that is being compressed by the drafted geometry 156 of the receptacle body 151 as the plug 110 is being inserted. The head clearance 125 of the screw 114 is also formed with tight tolerance and a draft angle so that the head of the screw 114 is compressing the rubber material. In both cases the compressed rubber material acts as a seal to prevent debris and humidity from entering the area of pins and contacts of the connector 100. Alternatively, in another implementation shown at A of FIG. 6, the sealing of the two above-mentioned locations is performed with a dedicated seal or other technique (such as an o-ring). As the plug 110 is being inserted to the receptacle 150 an alignment geometry 157 restricts the orientation of the plug with respect to the receptacle. In one implementation, the pins are spring-loaded and biased towards the receptacle contacts surface to ensure reliable connection of the pins and the contact even after prolonged and/or repeated use. For example, the alignment geometry 157 may be implemented as a key-and-keyway system to ensure proper rotational alignment of the plug 110 within the receptacle 150. In this implementation, the receptacle body 151 includes one or more keyways, or notches, formed on its mating surface. The plug body 111 includes a corresponding number of keys, or protrusions, that are dimensioned to fit within the keyways. This mechanical interface physically prevents the plug 110 from being inserted or fully seated unless it is in one of the N permitted rotational orientations, thereby ensuring that the electrical pins 113 align with a corresponding set of contacts 152.

Referring to FIG. 5 In one implementation the plug 110 includes four LEDs: LED 121 indicating the state, LED 122 indicating errors, LED 123 indicating the Link status of the ethernet communication and LED 124 indicating the activity status of the ethernet communication of the devices 60. In another implementation, additional components can be placed on the printed circuit board 117 like tactile buttons, or passive components to implement common circuits like Ethernet magnetics that is used to provide galvanic isolation, bridge rectifiers for reverse polarity protection or transient voltage protection circuits.

In one implementation, the connector achieves high connection density in a limited surface area while also enabling multiple rotational mounting orientations of the plug with respect to the receptacle. This is accomplished through a novel topological design method.

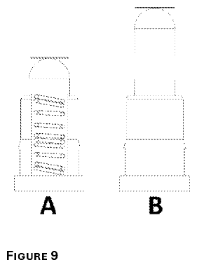

The mating surface of the receptacle is divided into N equal angular sections corresponding to N possible orientations (e.g., 4 sections for 90-degree rotational symmetry), as illustrated by the contact numbering in one section shown in FIG. 8 at A. In each section, a complete set of contacts is placed in a repeated, identical layout across all angular segments, as depicted in FIG. 8 at B. These contacts are wired in parallel so that the same logical signal is available at the same relative position in each section.

Electrical pins, which have a larger physical footprint than contacts, cannot all be located in a single section without reducing contacts'density or increasing overall connector size. Therefore, instead of placing all pins adjacent to the contacts in one section, the invention distributes the pins across all N sections to maximize spacing, as shown in the contact selection layout of FIG. 8 at C. Each pin is assigned to a distinct segment, ensuring sufficient physical spacing between neighboring pins.

In each of the N possible rotational orientations, the set of fixed pins aligns with a full group of contacts from one or more segments but not limited to a single segment. This guarantees electrical connection in any permitted orientation, while maximizing the number of connections within the limited connector footprint, as demonstrated by the pin alignment to the selected contacts in FIG. 8 at D. The resulting design avoids pin collision and enables significantly higher connections density than traditional connectors.

This topological distribution allows a connector with M pins and N orientations to interface with up to M×N contacts on the receptacle side, while using only M electrical pins and maintaining full functionality in all orientations. This principle relies on the fact that contacts occupy less area than pins. FIG. 9 illustrates the difference in physical size and spacing requirements between a spherical pin head and its corresponding flat contact. In the illustrated implementation, the pins are approximately 180% the diameter of the contacts, emphasizing why contacts can be repeated densely while pins must be distributed to prevent overlapping.

Referring to FIG. 4 and FIG. 5 for one implementation of the connector 100 where the device 60 is a force sensor (or other system component) mounted on the end effector of a robotic manipulator or other robotic system (or system in motion), where this system is equipped with a collision detection mechanism that immobilizes it to minimize damage and the plug body 111 is made out of rubber material and internally has been strengthened with a metallic insert 119. If in case of a collision of the system with the environment or itself the collision location is on the plug 110 the stiffness of the material and volume of the plug body 111 can be selected to dissipate the energy of the impact without damaging it. In the same implementation in the event of a collision of the system that application of a tensile force along the cable axis beyond a predetermined threshold results in disengagement or separation of the cable 112 from the plug 111. The disengagement or separation of the cable 112 from the plug 111 as a result of a collision-induced tensile force renders the cable non-functional. However, this failure mode is intentionally designed to localize damage to the cable itself, thereby preventing mechanical or electrical damage to the connector receptacle 150 and subsequently to the sensor device 60. As a result, device 60 operation can be restored by replacing the damaged plug 110, without requiring repair or replacement of the device 60.

Referring to FIG. 4 and in one implementation the Connector 100 has fifteen electrical connections and the plug 110 can mate with the receptacle 150 in four configurations. In this implementation the connector 100 is connecting USB, Ethernet and Indicators signals together with DC power 5-75V. The device 60 is a force torque sensor that operates on the basis of measuring voltage signals from strain gages with very high resolution. The quality of the analog measurements rely on the rejection of electromagnetic interferences conducted and non-conducted. In this implementation the to avoid non-conducted interference the sensor housing 61 is made out of a metallic material sealing the device electronic electronics from it, the cable 112 is shielded for the same reason and in order to connect electrically the shielding of the cable to the device housing 61 referring to FIG. 5 for the same implementation a metallic insert 119 is used that connects the cable shield through the printed circuit board 117 to the screw 114 that connects to the device housing 61. This way electromagnetic interferences can be rejected from the device housing 61 to the plug cable 112.

Referring to FIG. 4 in one implementation the receptacle 150 can be part of the device housing 61 and the contacts can be copper areas on a top surface of a flexible printed circuit board that extends inside the device 60 and connects to the device internal electronics. This configuration results in the cost of implementing the receptacle on the device 60 being significantly lower than conventional receptacles. In the same implementation of the connector 100, referring to FIG. 4 and FIG. 5, the plug 110 includes a printed circuit board 117 that can be assembled in high volumes with low cost and soldered on the plug cable 112. The plug body 111 can be formed in high volumes and with low cost with an over-molding technique. This implementation does not use any machined parts thereby reducing significantly the cost of the connector. Also, it incorporates LEDs that eliminate the need for incorporating them on the sensor housing 61 further reducing the total cost of production of the sensor device 60.

The connector may utilize a novel topological design method to achieve high connection density while enabling multiple rotational mounting orientations between the plug and receptacle. This method involves strategically distributing electrical pins and contacts across the mating surfaces. A breakaway functionality of the cable connection can be implemented through several means. In one implementation, the individual conductors of the plug cable 112 are soldered to the printed circuit board 117 using a minimal amount of solder designed to fail at a predetermined tensile force. In another implementation, the plug body 111 may include an internal, engineered score line or frangible section at the point of cable entry. This score line creates a stress concentration point, ensuring that under excessive tensile load, the plug body 111 tears at this specific location, releasing the cable 112 while leaving the internal electronics of the plug 110 and the receptacle 150 intact.

In some cases, the mating surface of the receptacle may be divided into multiple equal angular sections. Each section may contain an identical layout of electrical contacts. For example, the surface could be divided into four 90-degree sections, with each section having a full set of contacts arranged in the same pattern.

The electrical pins on the plug may be distributed across more than one of these angular sections, rather than being confined to a single section. This distribution allows for greater spacing between adjacent pins while maintaining a high overall connection density. Alternatively, the electrical pins can be distributed across the sections such that no two pins occupy the same segment.

In some implementations, the number of contacts on the receptacle may be a multiple of the number of pins on the plug, corresponding to the number of rotational orientations. For instance, a connector with 15 pins that can mate in 4 orientations may have 60 total contacts on the receptacle side.

The positioning of pins may be carefully selected such that in each permitted rotational orientation, the set of pins aligns with a complete group of contacts. This alignment may span across one or more angular sections of the receptacle surface.

To enable this high-density arrangement, the electrical contacts on the receptacle may occupy less surface area than the pin heads on the plug. The smaller footprint of the contacts allows them to be repeated more densely across the receptacle surface.

The topological distribution method described may allow for a significantly higher number of electrical connections within a given connector footprint compared to traditional designs, while maintaining full functionality across multiple orientations. This approach may be particularly beneficial for applications requiring compact connectors with high pin counts and flexible mounting options.

In implementations with biased contacts, the biasing force for the electrical contacts may be achieved through various mechanisms. While spring-loaded pins may be used in some implementations, examples of other options include:
Conductive elastomers: In some cases, a conductive elastomeric material may be used to form the contacts. These materials may provide both electrical conductivity and mechanical compliance, potentially eliminating the need for separate spring mechanisms.
Leaf spring contacts: Contacts may be formed from thin metal strips configured as leaf springs. These may provide a biasing force when compressed against the mating surface.
Cantilever beam contacts: The contacts may be designed as cantilever beams that deflect when mated, providing the necessary contact force.
Belleville washers: In some implementations, Belleville washers may be used to provide a spring force behind flat contact pads.
Magnetic biasing: Rare earth magnets may be incorporated to provide an attractive force between the plug and receptacle, ensuring good contact pressure.

The plug body may be manufactured using various materials and processes.

While over-molding with a flexible elastomer may be used in some cases, alternative approaches may include:
Injection molding of rigid thermoplastics for increased durability.
Two-shot molding to combine rigid and flexible materials in a single part.
3D printing for rapid prototyping or small-scale production.
Machining from solid stock for high-precision applications.

The receptacle contacts may be formed using different methods and materials. Alternatives to copper pads on a flexible printed circuit board may include:
Stamped and Formed Metal Contacts.
Plated through-holes in a rigid printed circuit board.
Conductive ink printed directly onto a substrate.
Wire bonding to create raised contact points.

In some cases, the visual indicators may be implemented using technologies other than LEDs, such as:
Electroluminescent (EL) Displays for a More Uniform Glow.
E-ink displays for low power consumption in applications where frequent updates are not required.
Fiber optic light pipes to transmit indicator light from internal LEDs to the exterior of the connector.
Mechanical or printed markers on the housings.

The sealing mechanism may be achieved through various means, including:
O-rings or gaskets made from different elastomeric materials.
Labyrinth seals for applications requiring IP67 or higher ingress protection.

The shielding and EMI protection may be implemented using different approaches, such as:
Conductive coatings applied to the interior of the connector housing.
Metal-loaded plastics for the connector body to provide inherent shielding.
Ferrite cores or beads incorporated into the cable assembly for additional EMI suppression.

These alternative structures, materials, and manufacturing methods may be selected based on specific application requirements, environmental conditions, cost constraints, or production volume considerations. The choice of alternatives may impact the connector's performance, durability, and overall cost-effectiveness.

1. A high-density, multi-orientation, low-profile electronic connector comprising:
a plug including a plug body, and a plurality of electrical pins that are distributed across multiple angular segments,
a receptacle including a contact surface with a plurality of electrical contacts, wherein the contacts are arranged in multiple angular segments around the mating surface of the receptacle, and the connector is configured to electrically connect in multiple rotational orientations of the plug with respect to the receptacle.

2. The connector of claim 1, wherein each angular segment of the receptacle includes a full set of contacts corresponding to all pins, and the pins are positioned such that, in each rotational orientation, they align with a distinct group of contacts.

3. The connector of claim 1, wherein the electrical pins are larger in footprint than the contacts, and the contacts are repeated more densely than the pins by distributing the pins across multiple angular sections.

4. The connector of claim 1, wherein the plug can be mated to the receptacle in four rotational orientations separated by 90 degrees.

5. An electronic connector plug comprising:
a plug body having an over-molded portion of a flexible elastomeric material;
a printed circuit board supporting spring-loaded electrical pins and visual indicators;
a cable terminated to the board; and
wherein the over-molded portion provides sealing, strain relief, and shock absorption, and the visual indicators comprise one or more LEDs configured to indicate power, error, and data link status.

6. The plug of claim 5, wherein the printed circuit board includes one or more of passive filtering components, galvanic isolation circuits for Ethernet, tactile input buttons, or transient protection components.

7. An electronic connector receptacle comprising:
a contact array formed as copper pads on the surface of a flexible printed circuit board, wherein the flexible circuit extends internally to the host device's internal electronics, and the receptacle is formed as an integrated part of the device housing without requiring separate machined parts.

8. An electronic connector plug configured to protect the host device against collision-induced damage, comprising:
a deformable plug body enclosing a metallic support insert; and
a breakaway cable connection that detaches under tensile stress above a defined threshold, wherein the breakaway protects the device-side receptacle and internal electronics from physical or electrical damage.

9. A method for designing a multi-orientation connector interface comprising:
dividing the receptacle contact surface into N equal angular sections;
defining an identical contact pad layout in each section;
distributing electrical pins across the sections such that no two pins occupy the same segment; and
aligning the pins in each of the N rotational plug orientations to one of the repeated contact segments, thereby enabling high-density electrical connection across all N orientations using fewer pins than total contacts.

10. The method of claim 9, wherein the number of contact pads is equal to M×N, where M is the number of pins and N is the number of orientations.
